(19) United States
(12) Patent Application Publication
(10) Pub. No.: US 2015/0091881 A1
(43) Pub. Date: Apr. 2, 2015

(54) OPERATING DEVICE

(71) Applicant: HONDA MOTOR CO., LTD., Tokyo (JP)

(72) Inventor: Junichiro Onaka, Utsunomiya-shi (JP)

(21) Appl. No.: 14/482,243

(22) Filed: Sep. 10, 2014

(30) Foreign Application Priority Data
Sep. 27, 2013 (JP) 2013-202647

(51) Int. Cl. G06F 3/0362; G06F 3/16; G06F 3/038; B60K 37/06; G09G 5/34

(52) U.S. Cl. CPC G06F 3/0362; B60K 37/06; G09G 5/34; G06F 3/038; G06F 3/165; G09G 2340/0464; G09G 2354/00; G09G 2380/10
USPC 345/184

(57) ABSTRACT

An operating device includes: an operating member; a rotation detecting unit; a capacitance detecting unit; a display unit; a storage unit; and a controller. In a case where the capacitance detecting unit detects a switch from presence of contact between the operating member and a finger of an operator to absence of the contact therebetween in a state where a rotational speed detected by the rotation detecting unit is a predetermined rotational speed or higher, the controller allows a scroll display of a plurality of display items to automatically continue regardless of a rotation state of the operating member after a timing of the switch.

### CROSS-REFERENCE TO RELATED APPLICATION

Priority is claimed on Japanese Patent Application No. 2013-202647, filed on Sep. 27, 2013, and the content of which is incorporated herein by reference.

### BACKGROUND OF THE INVENTION

1. Field of the Invention

The present invention relates to an operating device.

2. Description of Related Art

Conventionally, a playback device is known which controls the reading speed and the reading order of audio data and special playback such as scratch playback, according to the rotation direction, the rotational speed, and the amount of rotational change of a disc-shaped operating element which is rotatably operated, the presence or absence of contact between the operating element and a finger of an operator, and the like (for example, refer to Japanese Unexamined Patent Application, First Publication No. 2008-135147).

### SUMMARY OF THE INVENTION

However, in the playback device according to the related art, satisfactory operability cannot be realized by operating an interface according to only the operation of the operating element. For example, when the operation of the interface during the operation of the operating element is stopped at the time of stopping the operation of the operating element or at the point of time when the finger of the operator becomes separated from the operating element, there is concern that comfort and pleasure in the operation are degraded. For this reason, it is desirable to improve comfort of the operation of the operating element and pleasure in the movement of the interface.

The present invention has been made taking the foregoing circumstances into consideration, and an object thereof is to provide an operating device capable of improving comfort of an operation and pleasure in the movement of an interface.

In order to accomplish the object for solving the above-described problems, the following is employed.

(1) An operating device according to an aspect of the present invention includes: an operating member which is able to be rotated around a rotating shaft according to a rotation operation by an operator; a rotation detecting unit which detects a rotational speed of the operating member; a capacitance detecting unit which detects a presence or an absence of a contact between the operating member and a finger of the operator; a display unit which performs a display according to an operational input of the operator to the operating member; a storage unit which stores a plurality of display items; and a controller which controls a scroll display of the plurality of display items that are displayed on the display unit according to at least one of the rotational speed detected by the rotation detecting unit and the presence or the absence of the contact detected by the capacitance detecting unit, in which, in a case where the capacitance detecting unit detects a switch from the presence of the contact between the operating member and the finger of the operator to the absence of the contact therebetween in a state where the rotational speed detected by the rotation detecting unit is a predetermined rotational speed or higher, the controller allows the scroll display of the plurality of display items to automatically continue regardless of a rotation state of the operating member after a timing of the switch.

(2) In the operating device described in (1), when the scroll display of the plurality of display items is allowed to automatically continue after the timing of the switch, the controller may decelerate a movement speed to zero in a deceleration state corresponding to the rotational speed detected by the rotation detecting unit at the timing of the switch.

(3) In the operating device described in (1) or (2), in a case where the capacitance detecting unit detects a switch from the absence of the contact between the operating member and the finger of the operator to the presence of the contact therebetween in a state where the scroll display of the plurality of display items is allowed to automatically continue, the controller may stop a continuation of the scroll display of the plurality of display items so that the display item closest to a reference position is stopped at the reference position.

(4) In the operating device described in (2), the operating device may be mounted in a vehicle, and the controller may be able to change the deceleration state according to a travel state of the vehicle.

(5) In the operating device described in any one of (1) to (4), the capacitance detecting unit may be disposed close to the operating member.

(6) In the operating device described in (5), the operating member may include a clicking sensation imparting member which imparts a clicking sensation at each predetermined angle of a rotation of the operating member, and the capacitance detecting unit may be connected to the clicking sensation imparting member.

(7) In the operating device described in (5), the capacitance detecting unit may be disposed at a position separated from the operating member by a predetermined distance in an axial direction of the rotating shaft of the operating device.

(8) In the operating device described in any one of (1) to (7), the rotation detecting unit may have a detection resolution at which an angle of rotation of the operating member in a state where each of positions of the plurality of display items which are scrolled according to the rotation operation of the operator performed on the operating member is coincident with the reference position is able to be detected to be distinguished from an angle of rotation of the operating member in a state where each of the positions of the plurality of display items is not coincident with the reference position.

According to the operating device according to the aspect described in (1), since the scroll display of the plurality of display items is allowed to automatically continue regardless of the rotation state of the operating member after the finger of the operator becomes separated from the operating member, for example, compared to a case where only a scroll display linked with the rotation state of the operating member is performed, comfort of the operation and pleasure in the movement of the scroll display can be improved.

In a case of (2), by preparing in advance a map or the like which represents a predetermined correspondence relationship between the rotational speed and the deceleration state for achieving the comfort of the operation and the pleasure in the movement of the scroll display, the scroll display of the plurality of display items can be appropriately decelerated.

In a case of (3), if a desired display item is closer to the reference position than the other display items, the desired display item can be stopped at the reference position, resulting in an improvement in convenience.

In a case of (4), the deceleration state for achieving the comfort of the operation and the pleasure in the movement of the scroll display can be set by considering the senses, the intention in performing the operations, and the like of the operator which change according to the travel state of the vehicle.

In a case of (5), the configuration can be prevented from becoming complex. For example, in a case where the capacitance detecting unit is provided in the rotating operating member, a specific configuration (slip ring or the like) for transmitting a signal output from the capacitance detecting unit to the controller is needed. In contrast, by disposing the capacitance detecting unit close to the operating member, the signal output from the capacitance detecting unit can be transmitted to the controller without the specific configuration.

In a case of (6), since the clicking sensation imparting member comes into contact with the operating member, a change in the capacitance of the operating member can be detected via the clicking sensation imparting member, thereby there is no need for a specific configuration.

In a case of (7), even though the capacitance detecting unit is not in contact with the operating member, the capacitance detecting unit which has a size that enables the detection of a change in the capacitance of the operating member can be easily disposed at any position in the axial direction of the rotating shaft.

In a case of (8), the state where each of the positions of the plurality of display items is coincident with the reference position and the state where the reference position is present between the adjacent display items can be recognized to be distinguished from each other, thereby improving the minuteness of the operation.

### BRIEF DESCRIPTION OF THE DRAWINGS

FIG. 1 is a configuration diagram of an operating device according to an embodiment of the present invention.

FIG. 2 is a configuration diagram of an operating unit of the operating device according to the embodiment of the present invention.

FIGS. 3A, 3B, 3C, and 3D are diagrams illustrating examples of an operational input of an operator to the operating unit of the operating device according to the embodiment of the present invention, where FIG. 3A is a diagram illustrating a rotation operation in which a finger comes into contact, FIG. 3B is a diagram illustrating a pressing operation in a rotating a direction, and FIGS. 3C and 3D are diagrams illustrating a rotation operation in which the finger temporarily comes into contact.

FIG. 4 is a diagram illustrating an example of a display on a display unit in an album zapping mode and in a track zapping mode of the operating device according to the embodiment of the present invention.

FIG. 5 is a diagram illustrating an example of a display on the display unit in a case where the rotation operation is performed in which the finger comes into contact with the operating unit in the album zapping mode of the operating device according to the embodiment of the present invention.

FIG. 6 is a diagram illustrating an example of a display on the display unit in a case where the rotation operation is performed in which the finger temporarily comes into contact with the operating unit in the album zapping mode of the operating device according to the embodiment of the present invention.

FIG. 7A is a diagram illustrating an example of a change in movement distance of a scroll display with respect to time, and FIG. 7B is a diagram illustrating an example of a change in rotational speed of the scroll display with respect to time, in a case where the rotation operation, in which the finger temporarily comes into contact with the operating unit of the operating device according to the embodiment of the present invention, is performed at a predetermined rotational speed or higher.

FIGS. 8A and 8B are configuration diagrams of an operating unit of an operating device according to a modification example of the embodiment of the present invention, where FIG. 8A is a perspective view and FIG. 8B is a side cross-sectional view.

### DESCRIPTION OF EMBODIMENTS

Hereinafter, an operating device according to an embodiment of the present invention will be described with reference to the accompanying drawings.

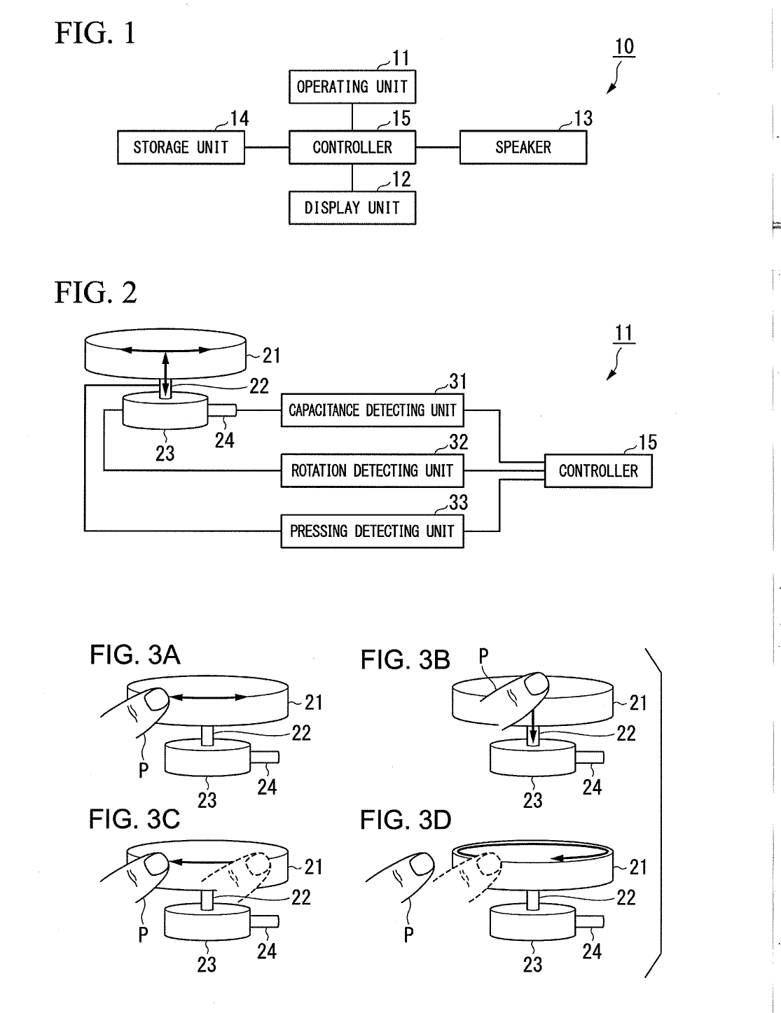

As illustrated in FIG. 1, an operating device 10 according to this embodiment includes an operating unit 11, a display unit 12, a speaker 13, a storage unit 14, and a controller 15. The operating device 10 is, for example, mounted in a vehicle.

As illustrated in FIG. 2, the operating unit 11 includes an operating member 21 having an annular plate shape, a rotating shaft 22 fixed to the operating member 21, a rotating member 23 fixed to the rotating shaft 22, and a click pin 24 protruding outward in the radial direction from the outer circumferential portion of the rotating member 23.

For example, the rotating shaft 22 is rotatably supported by a bearing member (not illustrated) and thus operating unit 11 is rotatable around the rotating shaft 22. Accordingly, for example, as illustrated in FIG. 3A, when a rotation operation is input by a finger P of an operator that comes into contact with the operating member 21, the operating member 21, the rotating shaft 22, the rotating member 23, and the click pin 24 integrally rotate around the rotating shaft 22.

The click pin 24 is provided to come into contact with an appropriate engagement member (not illustrated) disposed in the vicinity of the rotating member 23, and is elastically deformable and elastically restorable. The click pin 24 is elastically deformed by coming into contact with the engagement member at the time of each rotation of the operating unit 11 by a predetermined angle. At this time, a clicking sensation caused by the elastic force of the click pin 24 is imparted to the operating member 21. When the contact between the engagement member and the click pin 24 is released by the elastic deformation of the click pin 24, the click pin 24 is elastically restored. In addition, when the operating unit 11 further rotates by the predetermined angle, the click pin 24 comes into contact with the engagement member again.

The operating unit 11 includes, for example, a biasing member (not illustrated) in the operating member 21 or the rotating member 23 to bias the operating member 21 in a direction away from the rotating member 23 in the axial direction of the rotating shaft 22 so that the operating member 21 stops at a reference position in the axial direction in a state where an external force is not applied.

The operating member 21 can be moved from the reference position in the axial direction of the rotating shaft 22 to a predetermined position in a direction approaching the rotating member 23 when the external force against the biasing force of the biasing member is applied. Therefore, for example, as illustrated in FIG. 3B, when a pressing operation in the direction approaching the rotating member 23 in the axial direction is input by the finger P of the operator that comes into contact with the operating member 21, the operating member 21 is moved to be restored from the reference position to the predetermined position in the axial direction.

The operating unit 11 is configured so that the rotation thereof around the rotating shaft 22 is decelerated in a predetermined deceleration state according to the friction between the rotating shaft 22 and the bearing member (not illustrated) and the like. Therefore, for example, as illustrated in FIGS. 3C and 3D, in a case where a rotation operation is input by the finger P of the operator that comes into contact with the operating member 21 and thereafter the finger P of the operator becomes separated from the operating member 21, the rotation of the operating unit 11 is decelerated in the predetermined deceleration state and then stops.

The operating unit 11 includes, for example, a capacitance detecting unit 31 which is connected to a capacitance probe (not illustrated) that is provided in the click pin 24. The capacitance detecting unit 31 detects the presence or absence of the contact between the operating member 21 and the finger of the operator by using a signal which is output from the capacitance probe and indicates a change in the capacitance of the operating member 21, and outputs the detection signal.

The operating unit 11 includes, for example, a rotation detecting unit 32 which is connected to a rotational angle sensor (not illustrated) such as an optical sensor or a rotary encoder that is provided in the rotating member 23. The rotation detecting unit 32 detects a rotational speed of the operating member 21 according to the rotation operation of the operator by using a rotational angle signal output from the rotational angle sensor, and outputs the detection signal.

The operating unit 11 includes, for example, a pressing detecting unit 33 which is connected to a pressing sensor (not illustrated) such as a switch that is provided in the rotating shaft 22. The pressing detecting unit 33 detects the presence or absence of the pressing operation of the operator performed on the operating member 21 by using a signal which is output from the pressing sensor and indicates the presence or absence of movement of the operating member 21 in the axial direction, and outputs the detection signal.

The display unit 12 is, for example, a liquid crystal display or the like, and displays images, characters, and the like according to the operational input or the like of the operator to the operating member 21 according to a command signal which is output from the controller 15.

The speaker 13 outputs sound data (music data or the like), a voice, a signal sound, and the like corresponding to the operational input or the like of the operator to the operating member 21 in response to a command signal output from the controller 15.

The storage unit 14 stores image data displayed on the display unit 12, sound data, voice data, and signal sound data output from the speaker 13, character data which includes the titles and the like of the image data and the sound data, and the like.

The controller 15 is configured to include electronic circuits including a CPU (Central Processing Unit), a storage medium (not illustrated) which has a smaller capacity and a higher speed than the storage unit 14 such as a RAM (Random Access Memory), a timer, and the like. The controller 15 outputs a command signal for controlling the operation of the display unit 12, the operation of the speaker 13, and the like according to the detection signals output from the operating unit 11.

The operating device 10 according to this embodiment has the above-described configuration. Next, an operation of the operating device 10 will be described.

Hereinafter, an operation of selecting a plurality of pieces of sound data stored in the storage unit 14 will be described as an operation of the operating device 10.

When album data constituted by data of a plurality of audio tracks (tracks) as the sound data is an operation object, the controller 15 switches between an album zapping mode and a track zapping mode.

The album zapping mode is a mode in which playback candidates among data of a plurality of albums stored in the storage unit 14 or the like are sequentially switched to select any one of the playback candidates as a playback object. The track zapping mode is a mode in which playback candidates among data of a plurality of tracks constituting a single album selected in the album zapping mode are sequentially switched to select any one of the playback candidates as a playback object.

### (Display in Each Mode)

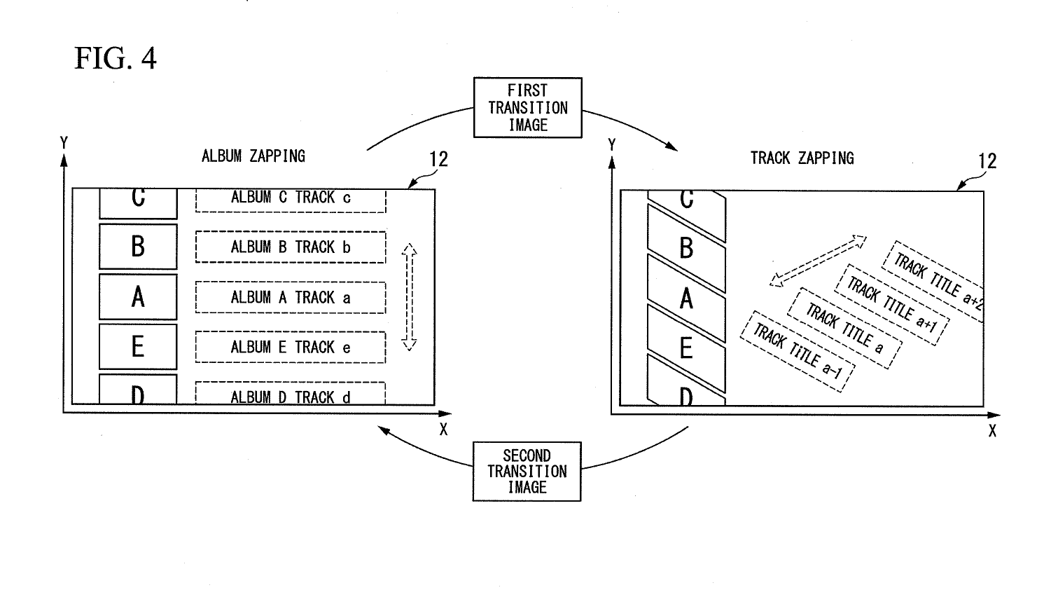

As illustrated in FIG. 4, in the album zapping mode, the controller 15 allows a plurality of display items which can be scrolled across the display unit 12 to respectively correspond to different albums, and displays image data such as the picture of each album and character data such as the title of each album, the title of a track that is a playback object at the current point in time in each album, and the like as the corresponding display item.

In the track zapping mode, the controller 15 fixes only partial data, for example, the image data of each display item in the album zapping mode so as not to be scrolled across the display unit 12, and displays the data in a different form from that in the album zapping mode.

Furthermore, the controller 15 allows the plurality of display items which can be scrolled across the display unit 12 to respectively correspond to different tracks constituting the album as the playback object at the current point in time, and displays the character data such as the title of each tack as the corresponding display item.

The controller 15 uses the display items corresponding to the playback candidates of the sound data as selection candidates, and uses the display item corresponding to the playback object of the sound data as a selection object.

For example, pieces of the image data A, B, C, D, and E of the albums are displayed on the display unit 12 illustrated in FIG. 4 in the album zapping mode and the track zapping mode. In the album zapping mode, pieces of the character data “album A track a”, “album B track b”, “album C track c”, “album D track d”, and “album E track e”, which include the titles of the albums and the titles of the tracks as the playback objects of the corresponding albums are displayed. In the track zapping mode, pieces of the character data “track a−1”, “track a”, “track a+1”, and “track a+2” which include the titles of the tracks constituting the album as the playback object are displayed. In addition, the frame shapes of the pieces of the image data A, B, C, D, and E of the albums in the album zapping mode and the frame shapes of the pieces of the image data A, B, C, D, and E of the albums in the track zapping mode are displayed in a different manner.

The controller 15 sets scrolling directions during a scroll display in the album zapping mode and in the track zapping mode to be different from each other. For example, in a two-dimensional orthogonal coordinate system in which the horizontal direction and the vertical direction of the display unit 12 respectively represent the X direction and the Y direction, the Y direction is the scrolling direction in the album zapping, and the X direction (or a direction intersecting the X direction at an acute angle) is the scrolling direction in the track zapping. Therefore, in each of the album zapping mode and the track zapping mode, the controller 15 allows the display items to be scrolled in the corresponding scrolling direction according to the rotation of the operating unit 11 around the rotating shaft 22, which is caused by the rotation operation performed on the operating member 21 by the finger of the operator.

The controller 15 switches between the album zapping mode and the track zapping mode according to the input of the pressing operation in the axial direction to the operating member 21 by the finger of the operator. For example, when the pressing detecting unit 33 detects the pressing operation of the operator performed on the operating member 21 in the album zapping mode, the controller 15 switches to the track zapping mode. On the other hand, when the pressing detecting unit 33 detects the pressing operation of the operator performed on the operating member 21 in the track zapping mode, the controller 15 switches to the album zapping mode.

When the controller 15 switches between the album zapping mode and the track zapping mode, the controller 15 displays a first transition image or a second transition image to temporarily negate the reception of various operational inputs of the operator on the operating unit 11.

### (Scroll Display According to Continuous Contact State of Finger)

When the rotation operation is input by the finger of the operator that comes into contact with the operating member 21 in each of the album zapping mode and the track zapping mode, the controller 15 scrolls the display items by a movement amount and at a movement speed corresponding to an operation amount and an operation speed of the rotation operation.

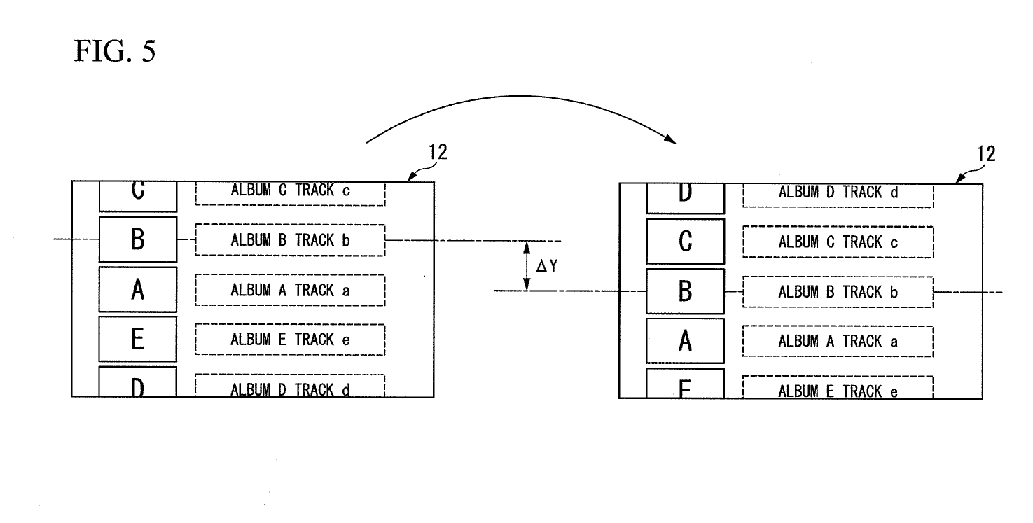

For example, in the album zapping mode illustrated in FIG. 5, when the rotation operation is input by the finger of the operator that comes into contact with the operating member 21, the controller 15 scrolls the display items by a movement amount ΔY corresponding to the operation amount, in a movement direction corresponding to the operation direction, and at a movement speed corresponding to the operation speed.

### (Scroll Display According to Temporary Contact State of Finger)

In a case where the finger of the operator becomes separated from the operating member 21 after the rotation operation at a predetermined rotational speed or higher is input by the finger of the operator that comes into contact with the operating member 21 in each of the album zapping mode and the track zapping mode, regardless of a subsequent rotation state of the operating unit 11, the controller 15 allows the scrolling of the display items to automatically continue. When the scrolling of the display items is allowed to automatically continue, the movement speed of the display items is decelerated to zero in a deceleration state corresponding to the rotational speed detected by the rotation detecting unit 32 at a timing at which the finger of the operator becomes separated from the operating member 21.

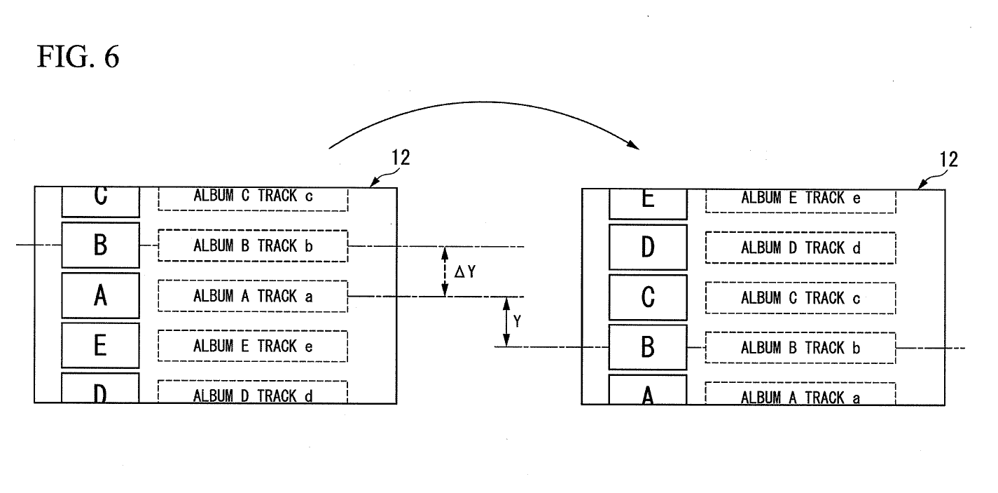

For example, in the album zapping mode illustrated in FIG. 6, when the rotation operation is input by the finger of the operator that comes into contact with the operating member 21, the controller 15 first scrolls the display items by the movement amount ΔY corresponding to the operation amount, in the movement direction corresponding to the operation direction, and at the movement speed corresponding to the operation speed. Subsequently, when the finger of the operator becomes separated from the operating member 21, the movement speed of the display items is decelerated to zero in the predetermined deceleration state corresponding to the rotational speed detected by the rotation detecting unit 32 at this timing. Therefore, the display items are scrolled by a movement amount Y (<ΔY) corresponding to the rotational speed and the predetermined deceleration state.

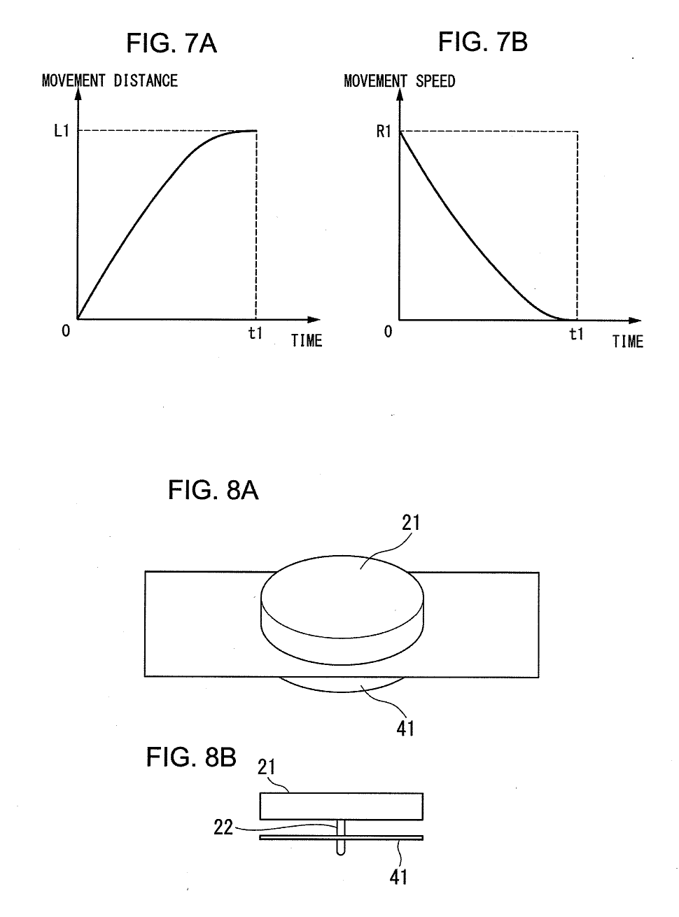

For example, as the predetermined deceleration state, as illustrated in FIG. 7A, by using a time t1 and a movement distance L1 corresponding to the rotational speed of the operating member 21 when the finger of the operator becomes separated from the operating member 21, the controller 15 may set an increase rate of the movement distance during the scrolling to gradually decrease toward the movement distance L1 after the time t1 elapses. In addition, for example, as illustrated in FIG. 7B, by using the time t1 and a movement speed R1 corresponding to the rotational speed of the operating member 21 when the finger of the operator becomes separated from the operating member 21, the movement speed during the scrolling may be set to gradually decrease from the movement speed R1 to zero after the time t1 elapses.

In a case where the capacitance detecting unit 31 detects a switch from the absence of the contact between the operating member 21 and the finger of the operator to the presence of the contact therebetween in the state where the scrolling of the display items automatically continues, the controller 15 stops the continuation of the scrolling of the plurality of display items so that the display item closest to the reference position is stopped at the reference position. The reference position is, for example, the center position of a display range of the scroll display.

As described above, according to the operating device 10 in this embodiment, the scroll display of the plurality of display items is allowed to automatically continue regardless of the rotation state of the operating member 21 after the finger of the operator becomes separated from the operating member 21. That is, even in a state where the rotation of the operating member 21 is stopped by friction or the like, the scroll display of the plurality of display items can automatically continue.

Accordingly, for example, compared to a case where only a scroll display linked with the rotation state of the operating member 21 is performed, comfort of the operation and pleasure in the movement of the scroll display can be improved.

Furthermore, by preparing in advance a map or the like which represents a predetermined correspondence relationship between the rotational speed and the deceleration state for achieving the comfort of the operation and the pleasure in the movement of the scroll display, the scroll display of the plurality of display items can be appropriately decelerated.

Moreover, when the finger of the operator comes into contact with the operating member 21 in the state where the scroll display of the plurality of display items automatically continues, if a desired display item is closer to the reference position than the other display items, the desired display item can be stopped at the reference position, resulting in an improvement in convenience.

In addition, for example, in a case where the capacitance probe is provided in the rotating operating member 21, a specific configuration (slip ring or the like) for transmitting a signal output from the capacitance probe to the capacitance detecting unit 31 and the controller 15 is needed. In contrast, by disposing the capacitance probe in the existing member (that is, click pin 24) close to the operating member 21, the signal output from the capacitance probe can be transmitted to the capacitance detecting unit 31 and the controller 15 without the specific configuration.

### Modification Example

In the above-described embodiment, the capacitance probe (not illustrated) is provided in the click pin 24. However, the capacitance probe is not limited thereto, and may be disposed at another position close to the operating member 21. For example, as illustrated in FIGS. 8A and 8B, a capacitance probe 41 may be disposed at a position separated from the operating member 21 by a predetermined distance in the axial direction of the rotating shaft 22 of the operating unit 11.

According to this modification example, the capacitance probe 41 which has a size that enables the detection of a change in the capacitance of the operating member 21 can be easily disposed at any position in the axial direction of the rotating shaft 22.

In the above-described embodiment, the controller 15 may change the predetermined deceleration state when the scrolling of the display items automatically continues, according to a travel state of a vehicle in which the operating device 10 is mounted. For example, the controller 15 suppresses the deceleration of the scrolling of the display items during the stopping of the vehicle compared to the deceleration during the traveling of the vehicle.

Accordingly, the deceleration state for achieving the comfort of the operation and the pleasure in the movement of the scroll display can be set by considering the senses, the intention in performing the operations, and the like of the operator which change according to the travel state of the vehicle.

In the above-described embodiment, the rotation detecting unit 32 may have a detection resolution at which the angle of rotation of the operating member 21 in a state where each of the positions of the plurality of display items which are scrolled according to the rotation operation of the operator performed on the operating member 21 is coincident with the reference position can be detected to be distinguished from the angle of rotation of the operating member 21 in a state where each of the positions of the plurality of display items is not coincident with the reference position.

Therefore, the state where each of the positions of the plurality of display items is coincident with the reference position and the state where the reference position is present between the adjacent display items can be recognized to be distinguished from each other, thereby improving the minuteness of the operation.

The operating member 21 may include a clicking sensation imparting member which imparts a clicking sensation thereto at each predetermined angle of rotation of the operating member 21. Furthermore, the capacitance detecting unit 31 may be connected to the clicking sensation imparting member.

The above-described embodiments are suggested as examples and are not intended to limit the scope of the present invention. The novel embodiments described above may be implemented in other various forms, and various omissions, substitutions, and changes may be made without departing from the concept of the present invention. The above-described embodiments and the modifications thereof are included in the scope and the concept of the present invention, and are included in the present invention described in the appended claims and the equivalent ranges thereof.

For example, in the above-described embodiments, the click pin 24 is provided in the operating unit 11. However, the click pin 24 is not limited thereto, and may be fixed to the surroundings of the rotating member 23. In this case, an engagement member which can come into contact with the click pin 24 may be provided in the outer circumferential portion of the rotating member 23.

As described above, the operating device 10 according to this embodiment includes: the operating member 21 which is able to be rotated around the rotating shaft according to the rotation operation by the operator; the rotation detecting unit 32 which detects the rotational speed of the operating member 21; the capacitance detecting unit 31 which detects the presence or the absence of contact between the operating member 21 and the finger P of the operator; the display unit 12 which performs a display according to an operational input of the operator to the operating member 21; the storage unit 14 which stores a plurality of display items; and the controller 15 which controls a scroll display of the plurality of display items that are displayed on the display unit 12 according to at least one of the rotational speed detected by the rotation detecting unit 32 and the presence or the absence of the contact detected by the capacitance detecting unit 31, and in a case where the capacitance detecting unit 31 detects a switch from the presence of the contact between the operating member 21 and the finger P of the operator to the absence of the contact therebetween in a state where the rotational speed detected by the rotation detecting unit 32 is a predetermined rotational speed or higher, the controller 15 allows the scroll display of the plurality of display items to automatically continue regardless of the rotation state of the operating member 21 after the timing of the switch. In addition, when the scroll display of the plurality of display items is allowed to automatically continue after the timing of the switch, the controller 15 decelerates a movement speed to zero in a deceleration state corresponding to the rotational speed detected by the rotation detecting unit 32 at the timing of the switch. In addition, in a case where the capacitance detecting unit 31 detects a switch from the absence of the contact between the operating member 21 and the finger P of the operator to the presence of the contact therebetween in a state where the scroll display of the plurality of display items is allowed to automatically continue, the controller 15 stops the continuation of the scroll display of the plurality of display items so that the display item closest to the reference position is stopped at the reference position. In addition, the operating device 10 is mounted in a vehicle, and the controller 15 is able to change the deceleration state according to the travel state of the vehicle. In addition, the capacitance detecting unit 31 is disposed close to the operating member 21. In addition, the operating member 21 includes the clicking sensation imparting member which imparts a clicking sensation at each predetermined angle of the rotation of the operating member 21, and the capacitance detecting unit 31 is connected to the clicking sensation imparting member. In addition, the capacitance detecting unit 31 is disposed at a position separated from the operating member 21 by a predetermined distance in the axial direction of the rotating shaft of the operating device 10. In addition, the rotation detecting unit 32 has a detection resolution at which the angle of the rotation of the operating member 21 in a state where each of the positions of the plurality of display items which are scrolled according to the rotation operation of the operator performed on the operating member 21 is coincident with the reference position is able to be detected to be distinguished from the angle of the rotation of the operating member 21 in a state where each of the positions of the plurality of display items is not coincident with the reference position.

What is claimed is:

1. An operating device comprising:
an operating member which is able to be rotated around a rotating shaft according to a rotation operation by an operator;
a rotation detecting unit which detects a rotational speed of the operating member;
a capacitance detecting unit which detects a presence or an absence of a contact between the operating member and a finger of the operator;
a display unit which performs a display according to an operational input of the operator to the operating member;
a storage unit which stores a plurality of display items; and
a controller which controls a scroll display of the plurality of display items that are displayed on the display unit according to at least one of the rotational speed detected by the rotation detecting unit and the presence or the absence of the contact detected by the capacitance detecting unit,
wherein, in a case where the capacitance detecting unit detects a switch from the presence of the contact between the operating member and the finger of the operator to the absence of the contact therebetween in a state where the rotational speed detected by the rotation detecting unit is a predetermined rotational speed or higher, the controller allows the scroll display of the plurality of display items to automatically continue regardless of a rotation state of the operating member after a timing of the switch.

2. The operating device according to claim 1,
wherein, when the scroll display of the plurality of display items is allowed to automatically continue after the timing of the switch, the controller decelerates a movement speed to zero in a deceleration state corresponding to the rotational speed detected by the rotation detecting unit at the timing of the switch.

3. The operating device according to claim 1,
wherein, in a case where the capacitance detecting unit detects a switch from the absence of the contact between the operating member and the finger of the operator to the presence of the contact therebetween in a state where the scroll display of the plurality of display items is allowed to automatically continue, the controller stops a continuation of the scroll display of the plurality of display items so that the display item closest to a reference position is stopped at the reference position.

4. The operating device according to claim 1,
wherein the capacitance detecting unit is disposed close to the operating member.

5. The operating device according to claim 1,
wherein the rotation detecting unit has a detection resolution at which an angle of rotation of the operating member in a state where each of positions of the plurality of display items which are scrolled according to the rotation operation of the operator performed on the operating member is coincident with the reference position is able to be detected to be distinguished from an angle of rotation of the operating member in a state where each of the positions of the plurality of display items is not coincident with the reference position.

6. The operating device according to claim 2,
wherein, in a case where the capacitance detecting unit detects a switch from the absence of the contact between the operating member and the finger of the operator to the presence of the contact therebetween in a state where the scroll display of the plurality of display items is allowed to automatically continue, the controller stops a continuation of the scroll display of the plurality of display items so that the display item closest to a reference position is stopped at the reference position.

7. The operating device according to claim 2,
wherein the operating device is mounted in a vehicle, and
the controller is able to change the deceleration state according to a travel state of the vehicle.

8. The operating device according to claim 2,
wherein the capacitance detecting unit is disposed close to the operating member.

9. The operating device according to claim 2,
wherein the rotation detecting unit has a detection resolution at which an angle of rotation of the operating member in a state where each of positions of the plurality of display items which are scrolled according to the rotation operation of the operator performed on the operating member is coincident with the reference position is able to be detected to be distinguished from an angle of rotation of the operating member in a state where each of the positions of the plurality of display items is not coincident with the reference position.

10. The operating device according to claim 4,
wherein the operating member includes a clicking sensation imparting member which imparts a clicking sensation at each predetermined angle of a rotation of the operating member, and
the capacitance detecting unit is connected to the clicking sensation imparting member.

11. The operating device according to claim 4,
wherein the capacitance detecting unit is disposed at a position separated from the operating member by a predetermined distance in an axial direction of the rotating shaft of the operating device.

12. The operating device according to claim 8,
wherein the operating member includes a clicking sensation imparting member which imparts a clicking sensation at each predetermined angle of a rotation of the operating member, and
the capacitance detecting unit is connected to the clicking sensation imparting member.

13. The operating device according to claim 8,
wherein the capacitance detecting unit is disposed at a position separated from the operating member by a predetermined distance in an axial direction of the rotating shaft of the operating device.
